(19) United States
(12) Patent Application Publication
(10) Pub. No.: US 2018/0350012 A1
(43) Pub. Date: Dec. 6, 2018

(54) ELECTRICAL CHARGER WITH ELECTRICAL POWER METERING

(71) Applicant: Samuel MESSINGER, Ramot Belt Shemesh Gimmel (IL)

(72) Inventor: Samuel MESSINGER, Ramot Belt Shemesh Gimmel (IL)

(21) Appl. No.: 15/706,801

(22) Filed: Sep. 18, 2017

Related U.S. Application Data
(60) Provisional application No. 62/514,850, filed on Jun. 4, 2017.

(51) Int. Cl. G06Q 50/06; G06Q 30/04; H02J 50/80; H02J 7/00; H01R 13/66; H01R 24/28

(52) U.S. Cl. CPC G06Q 50/06; G06Q 30/04; H02J 50/80; H01R 24/28; H02J 7/0052; H01R 13/6675; H01R 13/6691; H02J 7/0047

(57) ABSTRACT

The present invention is directed to the field of electrical device chargers and more particularly to metered electrical device chargers. The present invention relates in particular to the a metered electrical device charger, comprising: a housing defined by an outer surface from which a plurality of prongs are configured to protrude to couple to and receive power from a power source, where the outer surface is defined by at least one stopper that is configured to hold at least one electrically powered device in position on the housing while the at least one housing is coupled to the power source; and wherein said housing further comprises at least one payment transaction arrangement. The metered electrical device charger which is configured for charging said electrically powered device, optionally holding said electrically powered device while it is being charged, communicating time-stamp information to said cloud server, and communicating other relevant information with said cloud server. Further, the normal electrical outlet converted to dedicated electrical outlet where the metered electrical device charger is fixed with the help of retaining ring is also disclosed.

### (1) FIELD OF THE INVENTION

The present invention generally relates to the field of electrical device chargers. More particularly the invention relates to an electrical charger for mobile devices with electrical power metering arrangement.

### (2) BACKGROUND OF THE INVENTOR

The Inventor and his Family Messinger have a long and meritorious history of invention starting at the United States Patent Office in 1904 and spanning over a century of distinguished accomplishment in manufacturing and which is summarized in STATIONARY BEARNG RACE WITH UNIFORM DISTRIBUTION OF WEAR U.S. Pat. No. 9,631,673 B2 issued Apr. 25, 2017 to the Inventor, Samuel Messinger.

### (3) BACKGROUND OF THE INVENTION

There was a time when every mobile device, for example, mobile phone, iPad, and tablet, seemed to be supplied with their own individually unique charger. Previously one has had to remember to bring the right charging cable if you wanted to continue using your device while away from home. The Micro USB connector is now typically used by most mobile devices, which has gone a long way to obviating the need to carry around or having to find a unique charger for each mobile device.

A conventional charger for a cell phone comprises a charger body, a plug and an electric cord. However, when the charger is carried outdoors, the plug is not positioned and stored easily. In addition, the electric cord is easily tangled, thereby causing inconvenience to the user when using the charger. A conventional charger reel (or box) can be used to wind and store the electric cord. However, the conventional charger reel has a larger volume, thereby causing inconvenience in packaging, storage and transportation of the charger reel, so that the user cannot carry the charger reel easily and conveniently.

Access to electrical outlets to recharge the battery or supplying power to mobile device is now often either absent or free in public places such as e.g. hotels, railway stations, trains, airports, etc. In the first case, it is a real problem for users who need to recharge their electrical devices such as smartphones, tablets or laptops. In the other case, there is the problem of the cost of energy that is offered free to users, not to mention the cost of maintaining the electrical outlets.

A number of different type of the electrical chargers for mobile devices are available in the prior art. Further, there are number of devices also available for electrical power metering devices and method thereof. Such a solution is described for example in international patent application PCT/EP2012/053032. The system described in PCT/EP2012/053032 enables the billing of electric energy used when charging an electric vehicle. This system allows the identification of the vehicle recharging and billing of the charging operation. The described solution is complex and relies on standardized communication between the charging station and the vehicle, for example via a CAN bus (Controller Area Network, ISO 11898) on board the vehicle.

Another solution is presented in US patent application US2010332308. Such a solution enables billing of for use of a recharging operation, where payment can be made directly by the owner of the smartphone, for example by credit card on a payment terminal located next to the charging station. This system has the drawback of relying on adding a payment terminal, which greatly increases the cost of such an installation, not to mention the maintenance costs of such payment terminals.

Yet another prior art document, US20100306033 discloses a method and system for facilitating the purchase of electricity between a static provider (e.g., an Outlet Owner (OO)) and dynamic/mobile customer (e.g., a Plug Holder (PH)).

Another prior art document, US20150188591 discloses a cell phone charger holder that can completely receive and store the plug and the electric cord of a charger. The cell phone charger holder includes a main body, a plug, and an electric cord. The plug has two pins referred to as male which fit into matching slots or holes called male. The main body has a front face provided with a receiving chamber for receiving the plug. The main body has a side provided with an annular groove for winding the electric cord. The main body has a lower portion provided with two positioning hooks for placing a cell phone. This reference is discusses only for cell phone charger holder.

Yet another prior art document, apple's recently issued US patent, U.S. Pat. No. 9,614,378 discloses a inductive charging interface with magnetic retention can be used for charging electronic devices and accessories. For example, a magnetic core of an inductive charging configuration may be divided into two magnetic elements, one element can be housed within a receptacle or receiving connector of housing of an electric device and the other element can be housed within a plug or transmission connector. The poles of the two elements of the magnetic core may create a magnetic field to retain the plug connector in an aligned, mated position with the receptacle connector of the electronic device.

Yet another prior art document, US20160211609 discloses a charger adaptor for a mobile device that has a connection outlet, the charger adaptor includes: an insertion plug formed with a plurality of contact electrodes, the insertion plug having a shape complementary to an interior shape of the connection outlet; a plug body extending away from the insertion plug and extending outside the connection outlet, the plug body having exteriorly facing electrical contacts that are in respective electrical continuity with the contact electrodes. The reference discusses use of magnet in the charger adaptor to hold mobile devices.

Yet another prior art document, U.S. Pat. No. 9,421,880 discloses an add-on communication device attached to a cable installment type charging control device attached to a cable assembly for charging an electric vehicle.

Yet another prior art document, WO2015124854 discloses a device allowing the electrical powering of an electrical appliance, having a remote control module allowing the activation of the electrical supply of the electrical appliance and allowing the reception of messages, the device comprising means for detecting the connection of the electrical appliance, the detection of the connection triggering a phase of electrical powering of the electrical appliance for a first duration, and, on receipt of a message during the first duration, maintaining the electrical supply of the electrical appliance beyond the first duration.

Yet another prior art document, US20150317755 discloses an electric power information management apparatus includes a power meter that measures electric power data on electric power to be supplied from a storage battery of a vehicle to an electric power facility; a security module that associates and encrypts identification information corresponding to the vehicle and the measured electric power data; a communication device that transmits to an electric power management database the identification information corresponding to the vehicle and the electric power data encrypted by the security module to store the electric power data associated with the identification information in the electric power management database; and an electric power control device that extracts necessary electric power from the electric power facility and supplies the electric power to the storage battery of the vehicle.

Yet another prior art document, US20160031339 discloses a location-based charging/discharging power mediation system of an electric vehicle, and more particularly to a module, an electric vehicle, and an intermediate server for location-based charging/discharging power mediation.

Yet another non-patent literature (NPL) prior art document discloses a product available in market, which is plug-in energy monitor power meter electricity electric usage monitoring outlet (see: http://www.ebay.co.uk/itm/Plug-in-Energy-Monitor-Power-Meter-Electricity-Electric-Usage-Monitoring-Outlet-/231083500237).

Yet another non-patent literature (NPL) prior art document discusses another product available in the market, which is a power consumption meter energy monitor KWH calculator usage plug in electricity (see: http://www.ebay.co.uk/itm/Power-Consumption-Meter-Energy-Monitor-KWH-Calculator-Usage-Plug-In-Electricity-/142313933330).

Yet another non-patent literature (NPL) prior art document discloses another product available in the market for monitoring energy consumption by wireless device. Using this device one can monitor energy usage of any device plugged into the HS110 right from your phone. One can also turn electronics on or off from anywhere with your tablet or smartphone using the free Kasa app (Compatible w/ Android 4.1 or higher & iOS8 or higher). Use Away-Mode to turn devices on and off at different times to give the appearance that someone is home while you are away (see: http://www.ebay.in/itm/172669940040?aff_source=Sok-Goog).

However, above mentioned references have one or more of the following shortcomings: (i) they apply only to electrical power metering device for electrical vehicles; (ii) they require long cables; (iii) proprietary charging cables are required; (iv) they require a physically separate docking station; and (v) they are not easy to carry during travel.

The present application addresses the above mentioned concerns and short comings.

### (4) SUMMARY OF THE INVENTION

In the view of the foregoing disadvantages inherent in the known types of energy consumption metering or monitoring devices now present in the prior art, the present invention provides an improved electrical charger for mobile devices that comprises an electrical power metering arrangement that can also hold the mobile devices.

An object of the present invention is provide a method and device by which electrical usage costs can be recouped by establishments such as restaurants, eateries, coffee shops, and other public places.

An object of the present invention is to enable monitoring of electrical usage by electrical devices when mobile devices are connected to electrical power outlets whose electricity costs are not paid by the owners of the mobile devices.

In one embodiment the present invention comprises: a housing defined by an outer surface from which a plurality of prongs are configured to protrude to couple to and receive power from a power source, where the outer surface is defined by at least one stopper that is configured to hold at least one electrically powered device in position on the housing while the at least one housing is coupled to the power source; and wherein the housing further comprises at least one payment transaction arrangement.

In one embodiment the at least one payment transaction arrangement comprises a card swiping slot.

In one embodiment the card swiping slot is configured to receive a credit card, debit card, or smart card.

In one embodiment the at least one payment arrangement is configured to debit the credit card, debit card, or smart card for usage of the at least one electrically powered device.

In one embodiment the payment transaction arrangement is configured to communicate credit card, debit card, or smart card payment information wirelessly.

In one embodiment the housing further comprises a connector configured to connect to a card swipe reader.

In one embodiment the at least one stopper comprises a channel extending across a top of the housing.

In one embodiment, along an entire length of the channel, the channel is defined by a cross-sectional shape selected from the group consisting of a right angle, an angle other than a right angle, a curve, and a combination thereof.

In one embodiment the plurality of prongs are configured to couple to a 220 V or 110 V wall outlet.

In one embodiment the electric power source is selected from the group consisting of: an alternating current (AC) source and a direct current (DC) source.

In one embodiment, the present invention further comprises at least one intelligent chip configured to communicate with a cloud server.

In one embodiment the intelligent chip communicates information comprised of user information, electrical power usage information, location information, or time-stamp information to the cloud server.

In one embodiment the location information comprises a location owner name, a location area, or an electrical outlet reference number.

In one embodiment the time-stamp information includes a start-up time and a shut off-time that indicates how long the at least one electrically powered device has been electrically connected to the electrical device charger.

In one embodiment the at least one electrically powered device comprises a mobile phone, an i-Pad computer device, a music player device, a CD player, a tablet computer, or a laptop computer.

In one embodiment the present invention comprises a retaining mechanism by which the electrical device charger is fixedly attached to the wall outlet.

In one embodiment the retaining mechanism comprises a retaining ring.

In one embodiment the retaining mechanism comprises a threaded retaining ring.

In one embodiment wherein the electrical device charger is configured to charge the electrically powered device while holding the electrically powered device and to communicate with a cloud server.

In this respect, before explaining at least embodiments of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### (5) BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 depicts metered electrical device charger including a stopper and a card swiping slot for the payment transaction according to the preferred embodiment of the present invention.

FIG. 2 depicts metered electrical device charger including a stopper and an in-built wireless facility for the payment transaction according to another preferred embodiment of the present invention.

FIGS. 3 and 4 depict card swipe readers which are available in the prior art.

FIG. 5 depicts perspective view of the metered electrical device charger including a stopper and a card swiping slot for the payment transaction.

FIG. 6 depicts side view of an electrical device charger including a stopper and an audio jack facility to which the card swipe adapters of FIGS. 3 and 4 can be attached.

FIG. 7 depicts metered electrical device charger including an angled stopper and an in-built wireless facility for the payment transaction according to the preferred embodiment of the present invention.

FIG. 8 depicts 220 V metered electrical device charger adapter including a stopper and an in-built wireless facility for the payment transaction according to the preferred embodiment of the present invention.

FIG. 9 depicts 110 V metered electrical device charger adapter including a stopper and an in-built wireless facility for the payment transaction according to the preferred embodiment of the present invention.

FIG. 10 depicts three prongs metered electrical device charger including a stopper and an in-built wireless facility for the payment transaction according to the preferred embodiment of the present invention.

FIG. 11 represents the flow chart of the method of charging an electrically powered device and metering/calculating the electrical power consumption during the charging.

FIG. 12 depicts a retaining ring for dedicated electrical outlet to which a metered electrical device charger is attached.

FIG. 13 depicts metered electrical device charger including a stopper, a card swiping slot for the payment transaction, and also in-built wireless facility for the payment transaction.

FIG. 14 depicts assembly of metered electrical charger device fixed to the electrical outlet to convert it to dedicated electrical outlet.

### (6) DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

As used herein the term “stopper” is intended to apply to slots, channels, grooves, protrusions, stops and other similar structures that are provided to the housing of a device charger to enable holding and retaining of electrical devices on or in the housing.

As used herein the terms “prongs” and “pins” are intended to encompass a class of structures provided to the housing of an electrical device charger to enable electrical connection of the housing to an electrical power sources.

As used herein, the term stopper refers to structure designed and intended to hold electrical devices on a wall mounted electrical device charger and/or adapter. In embodiments, a stopper may comprise a channel, slot, groove, protrusion, stop or other structure configured to hold electrical devices on a wall mounted electrical device charger and/or adapter. In one embodiment, a stopper can be defined by opposing sides that are parallel. In one embodiment, a stopper can be defined by opposing sides that are non-parallel. In one embodiment, a stopper may be defined by sides that have portions that are both parallel and non-parallel. In embodiments, the stopper comprises a cross-section with a u-shape or a v-shape or both a v-shape and a u-shape. In embodiments, a stopper may be outside or inside the housing of an electrical device charger and/or adapter. In one embodiment, a cross-sectional shape of the stopper is defined by a shape selected from the group consisting of a right angle, an angle other than a right angle, a curve, and a combination thereof.

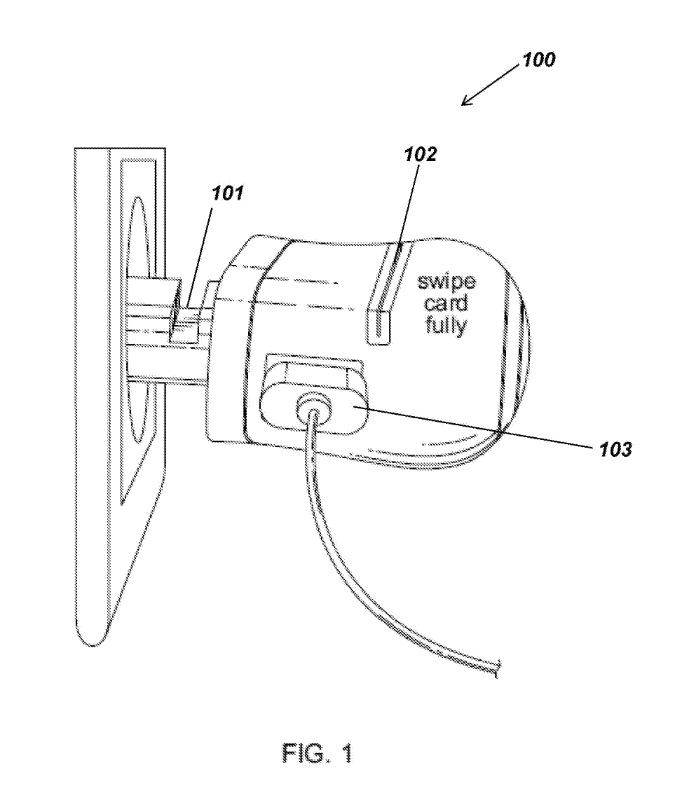

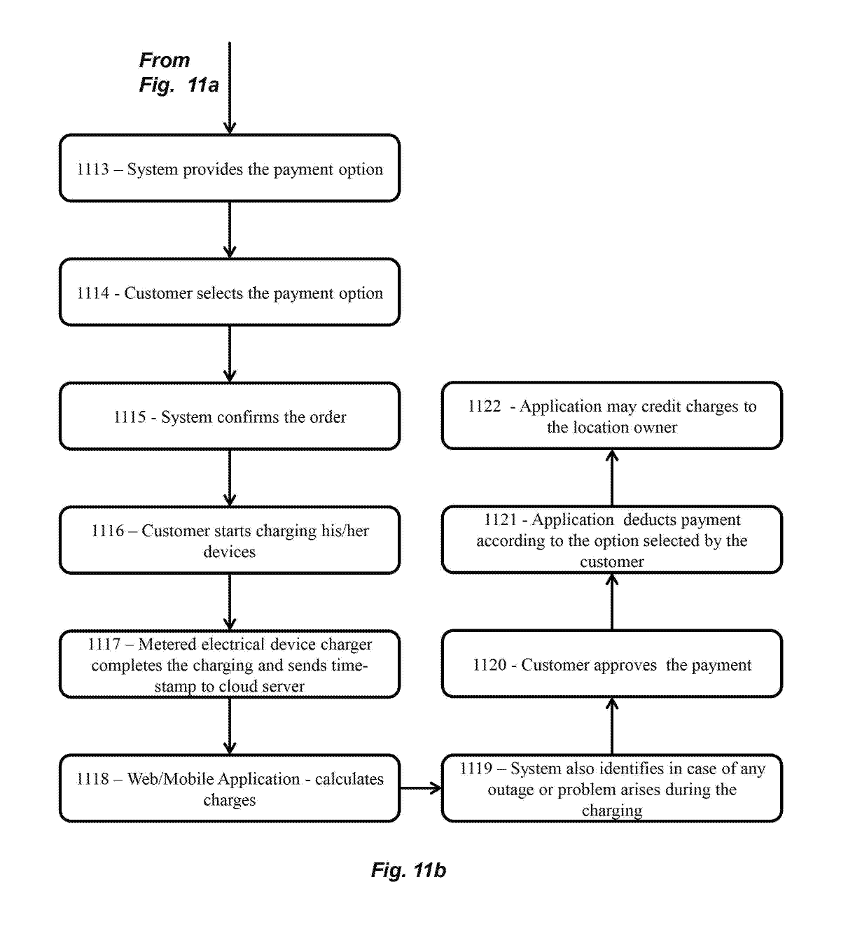

In an exemplary embodiment of the present invention, FIG. 1 depicts metered electrical device charger including a stopper and a card swiping slot for the payment transaction. The metered electrical device charger, comprising: a housing 100 defined by an outer surface from which a plurality of prongs (not visible in the present Fig. as the metered electrical device charger is connected to the electrical outlet) are configured to protrude to couple to and receive power from a power source, where the outer surface is defined by at least one stopper 101 that is configured to hold at least one electrically powered device in position on the housing 100 while the at least one housing is coupled to the power source; and wherein the housing further comprises at least one payment transaction arrangement 102. The payment transaction arrangement 102 is a card swiping slot on the outer surface of the housing. The electrical cord 103 for connecting the housing to the electrically powered device. The stopper 101 in the present embodiment is like a channel or groove type of arrangement, however it can be any different designs which can securely hold the electrically powered device. Further, the electric power source can be selected from the group consisting of: an alternating current (AC) source and a direct current (DC) source. Additionally, the housing can be directly connected to either 220 V or 110 V electrical power source or it may be like an electrical charger adapter. The housing 100 further also comprises an intelligent chip which facilitates the housing (metered electrical device charger) to communicate different information with the cloud server. The housing 100 has an arrangement to accept payment either by credit card, debit card, smart card, wireless smart type payment or similar type of payment and then the housing 100 transfers such information to the cloud server. The intelligent chip (which is not visible in the figure, as it is in-built attached in the device) communicates information such as user information, electrically powered device information, location information, and time-stamp information to the cloud server. The intelligent chip provides constant current, constant voltage charging, automatic identification, built-in protection circuit prevents overcharging, and automatically stop charging (when the electrical device is fully charged). The location information may be location owner name, location area, electrical outlet reference number, and any other similar information related to the location. The time-stamp information includes start-up time and shut off-time between which the electrically powered device is connected to the electrical outlet for the charging. The electrically powered device comprises a mobile phone, i-Pad computer device, a music player device, a CD player, a tablet computer, or a laptop computer. The server can be localized server or remote server or cloud server. The cloud server comprises Azure, AWS or any similar server. A detail explanation on how the metered electrical device charger works is provided later in the patent application (see FIG. 11 flow chart and its description).

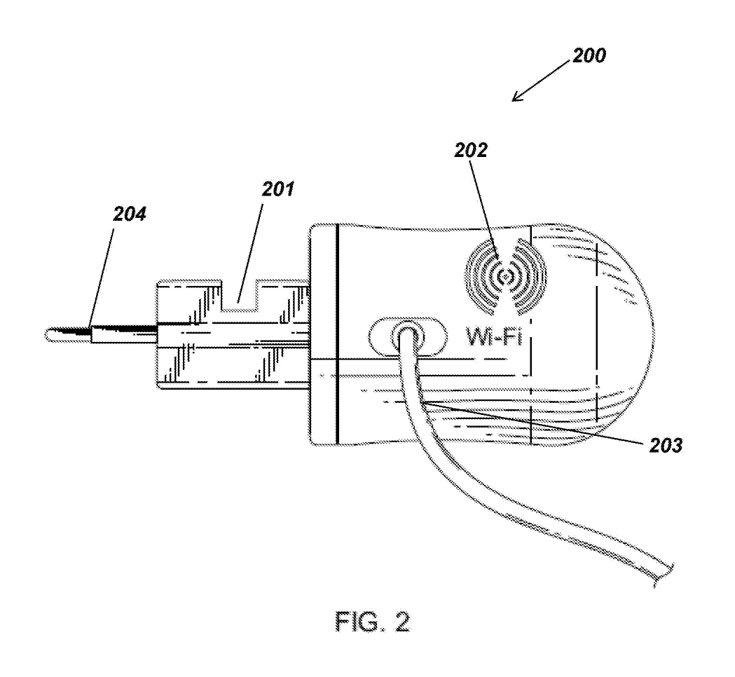

In an exemplary embodiment of the present invention, FIG. 2 depicts metered electrical device charger including a stopper and an in-built wireless facility for the payment transaction. The metered electrical device charger, comprising: a housing 200 defined by an outer surface from which a plurality of prongs 204 are configured to protrude to couple to and receive power from a power source, where the outer surface is defined by at least one stopper 201 that is configured to hold at least one electrically powered device in position on the housing 100 while the at least one housing is coupled to the power source; and wherein the housing further comprises at least one payment transaction arrangement 202. The plurality of prongs 204 can be configured to couple to a 220 V or 110 V wall outlet. The payment transaction arrangement 202 is in-built wireless facility into the housing 200. The payment transaction arrangement 202 can accept payment transaction details from the electrically powered devices. The electrical cord 203 for connecting the housing to the electrically powered device. The stopper 201 in the present embodiment is like a channel or groove type of arrangement; however it can be any different designs which can securely hold the electrically powered device. The stopper 201 comprises a channel extending into a top of the housing. Further, the channel can be defined by a cross-sectional shape selected from the group consisting of a right angle, an angle other than a right angle, a curve, and a combination thereof. Further, the electric power source can be selected from the group consisting of: an alternating current (AC) source and a direct current (DC) source. Additionally, the housing can be directly connected to either 220 V or 110 V electrical power source or it may be like an electrical charger adapter. The housing 200 further also comprises an intelligent chip which facilitates the housing (metered electrical device charger) to communicate different information with the cloud server. The housing 200 has an arrangement to receive payment transaction details wirelessly from the electrically powered devices and then the housing 200 transfers such information to the cloud server. The intelligent chip (which is not visible in the figure, as it is in-built attached in the device) communicates information such as user information, electrically powered device information, location information, and time-stamp information to the cloud server. The location information may be location owner name, location area, electrical outlet reference number, and any other similar information related to the location. The time-stamp information includes start-up time and shut off-time between which the electrically powered device is connected to the electrical outlet for the charging. The electrically powered device comprises a mobile phone, i-Pad computer device, a music player device, a CD player, a tablet computer, or a laptop computer. A detail explanation on how the metered electrical device charger works is provided later in the patent application (see FIG. 11 flow chart and its description).

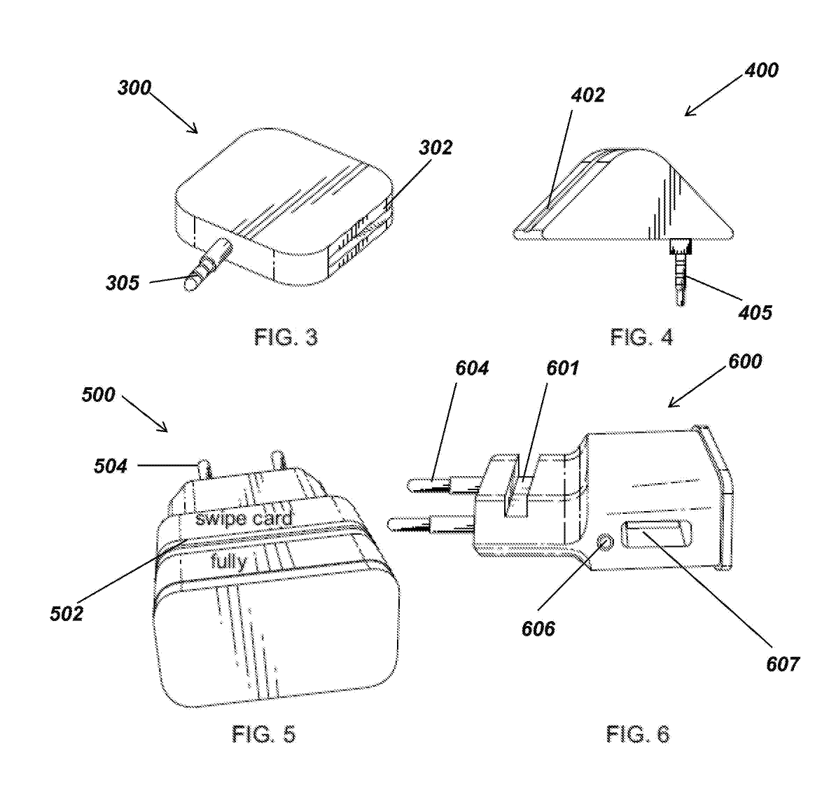

FIGS. 3 and 4 depict card swipe readers which are available in the prior art. The card swipe readers has audio jack for the connecting and also has facility to read magnetic strips of the cards or smart cards by swiping thru. Further, the audio jack 305 or 405 can connect with any other mobile devices or with other apparatuses.

FIG. 5 depicts perspective view of the metered electrical device charger including a stopper and a card swiping slot for the payment transaction, which has similar arrangement as explained earlier for FIG. 1.

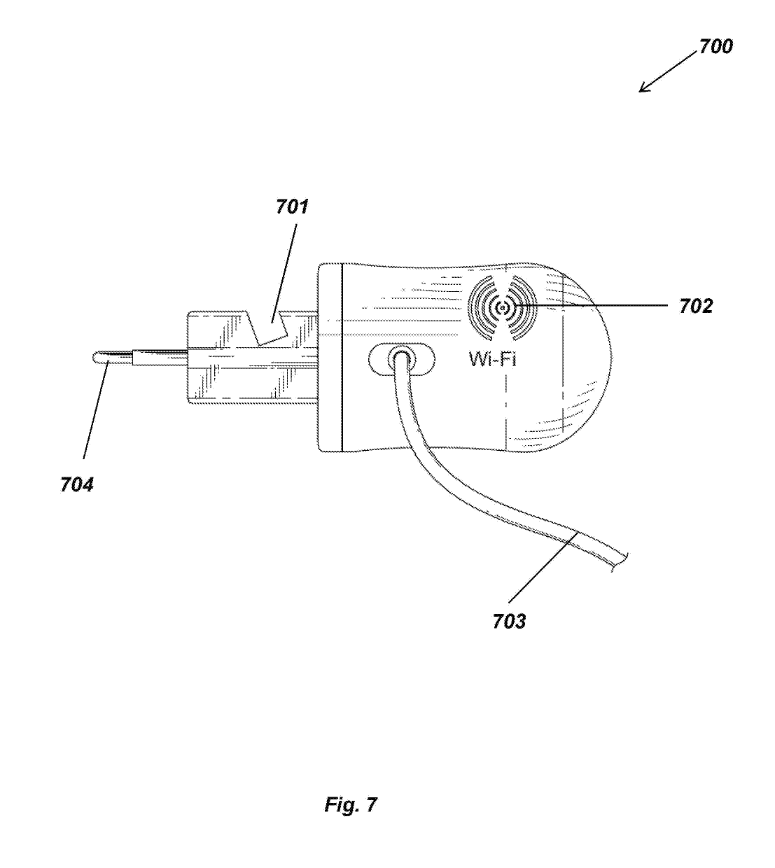

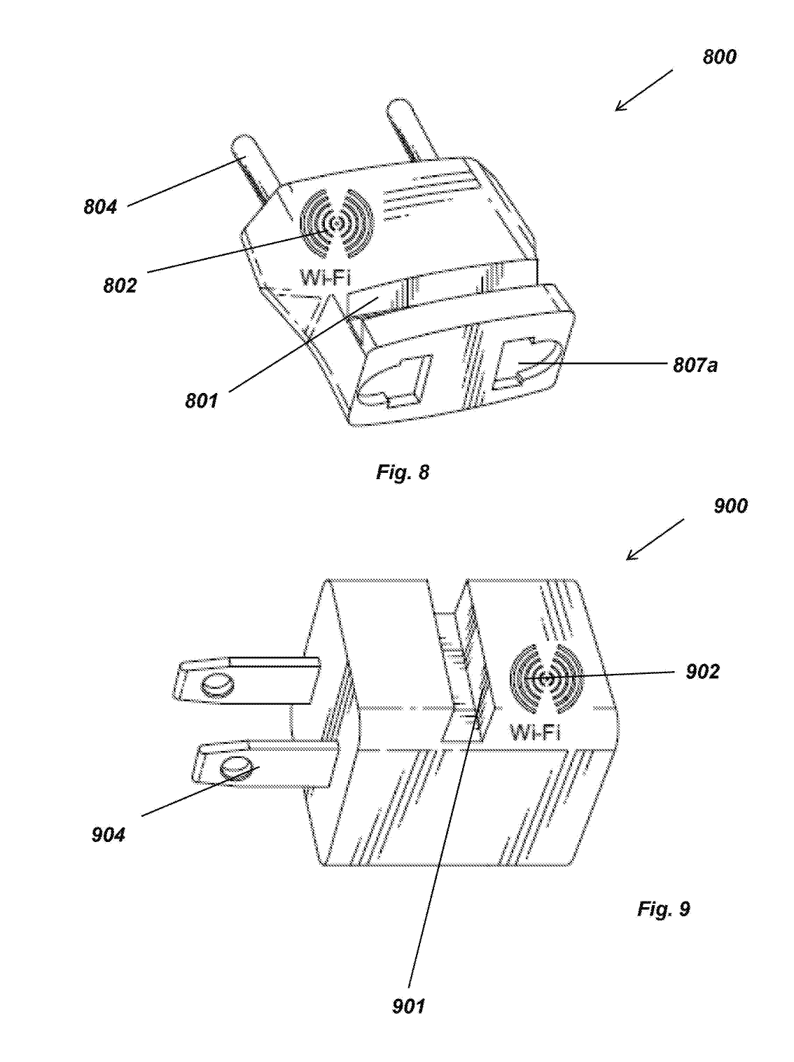

In an exemplary embodiment of the present invention, FIG. 6 depicts a side view of an electrical device charger including a stopper and an audio jack facility to which the card swipe adapters of FIGS. 3 and 4 can be attached. The metered electrical device charger, comprising: a housing 600 defined by an outer surface from which a plurality of prongs 604 are configured to protrude to couple to and receive power from a power source, where the outer surface is defined by at least one stopper 601 that is configured to hold at least one electrically powered device in position on the housing 600 while the at least one housing is coupled to the power source; and wherein the housing further comprises at least one payment transaction arrangement 602. The plurality of prongs 604 can be configured to couple to a 220 V or 110 V wall outlet. The payment transaction arrangement 602 is an audio jack connector slot 606 with which a card swipe reader 300 or 400 can be connected into the housing 600. The payment transaction arrangement 102 is a card swiping slot 302 or 402 on the outer surface of the card swipe readers. The housing 600 comprises a connector 607 for electrically connecting the cable cord to the at least one electrical powered device. The stopper 601 in the present embodiment is like a channel or groove type of arrangement; however it can be any different designs which can securely hold the electrically powered device. The stopper 601 comprises a channel extending into a top of the housing. Further, the channel can be defined by a cross-sectional shape selected from the group consisting of a right angle, an angle other than a right angle, a curve, and a combination thereof. Further, the electric power source can be selected from the group consisting of: an alternating current (AC) source and a direct current (DC) source. Additionally, the housing can be directly connected to either 220 V or 110 V electrical power source or it may be like an electrical charger adapter. The housing 600 further also comprises an intelligent chip which facilitates the housing (metered electrical device charger) to communicate different information with the cloud server. The housing 600 has an arrangement to receive payment transaction details wirelessly from the electrically powered devices and then the housing 600 transfers such information to the cloud server. The intelligent chip (which is not visible in the figure, as it is in-built attached in the device) communicates information such as user information, electrically powered device information, location information, and time-stamp information to the cloud server. The location information may be location owner name, location area, electrical outlet reference number, and any other similar information related to the location. The time-stamp information includes start-up time and shut off-time between which the electrically powered device is connected to the electrical outlet for the charging. The server can be localized server or remote server or cloud server. The cloud server comprises Azure, AWS or any similar server. A detail explanation on how the metered electrical device charger works is provided later in the patent application (see FIG. 11 flow chart and its description).

In an exemplary embodiment, FIG. 7 depicts metered electrical device charger including an angled stopper and an in-built wireless facility for the payment transaction according to the preferred embodiment of the present invention, which has similar arrangement as explained earlier for FIG. 2. However, FIG. 7 embodiment, the stopper is of angled type. The electrical device is sitting securely on the angled stopper and is leaning on the wall.

In exemplary embodiments of the present invention, FIGS. 8 and 9 depicts an electrical adapter design for charging an electrical devices. FIG. 8 depicts 220 V metered electrical device charger adapter including a stopper and an in-built wireless facility for the payment transaction. The metered electrical device charger, comprising: a housing 800 defined by an outer surface from which a plurality of prongs 804 are configured to protrude to couple to and receive power from a power source, where the outer surface is defined by at least one stopper 801 that is configured to hold at least one electrically powered device in position on the housing 800 while the at least one housing is coupled to the power source; and wherein the housing further comprises at least one payment transaction arrangement 802. The plurality of prongs 804 can be configured to couple to a 220 V. The payment transaction arrangement 802 is in-built wireless facility into the housing 800. The payment transaction arrangement 802 can accept payment transaction details from the electrically powered devices. The housing 800 has Female socket 807a with which another adapter/electrical plug can attach. The stopper 801 in the present embodiment is like a channel or groove type of arrangement; however it can be any different designs which can securely hold the electrically powered device. The stopper 801 comprises a channel extending into a top of the housing.

FIG. 9 depicts 110 V metered electrical device charger adapter including a stopper and an in-built wireless facility for the payment transaction according to the preferred embodiment of the present invention, which has similar arrangement as explained earlier for FIG. 8. However, FIG. 9 is of electrical device charger of 110 V having two flat prongs.

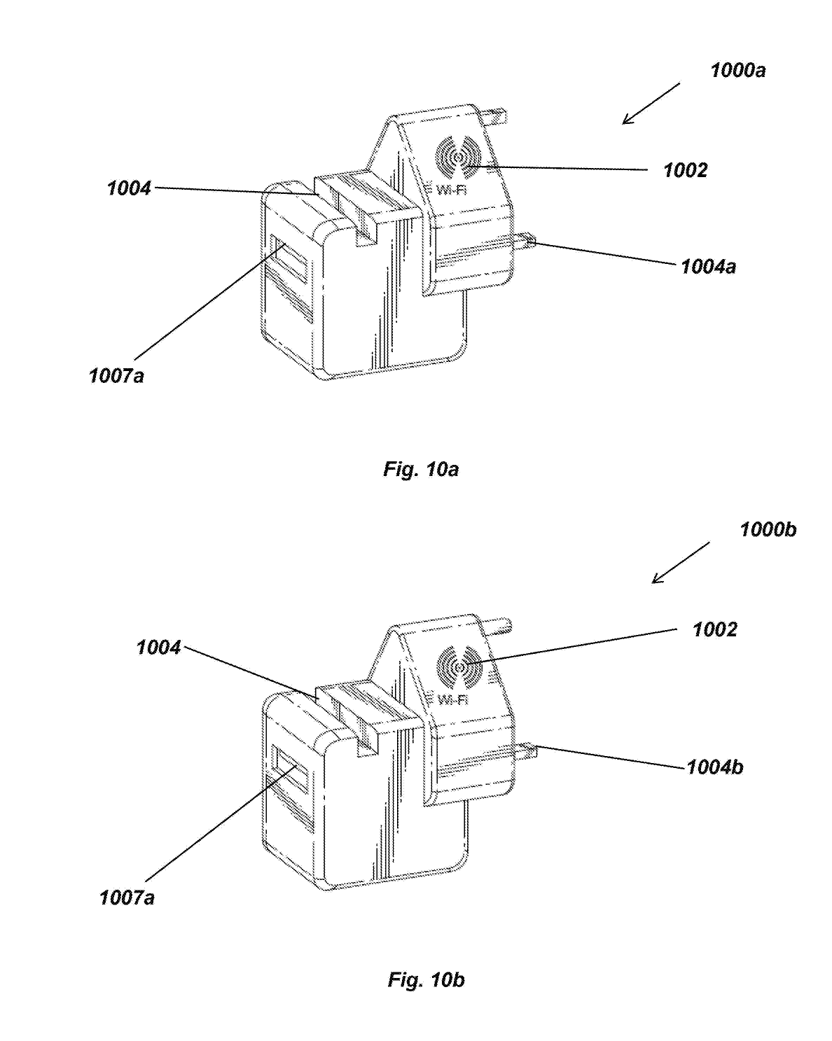

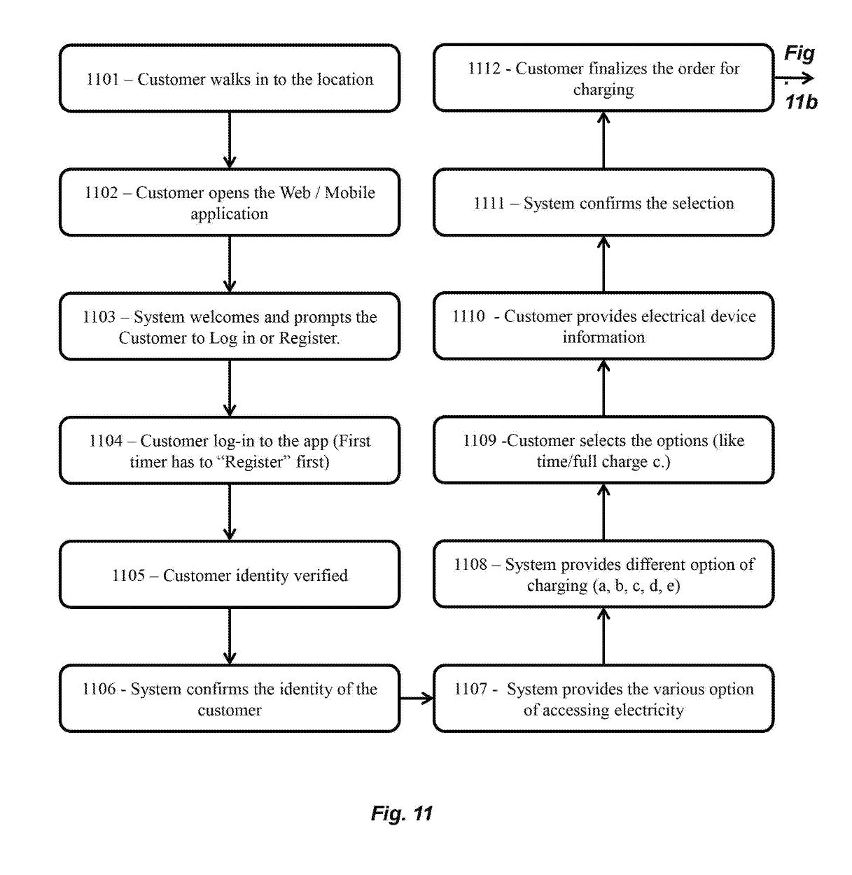

In exemplary embodiments of the present invention, FIGS. 10a and 10b depicts three prongs metered electrical device charger including a stopper and an in-built wireless facility for the payment transaction according to the preferred embodiment of the present invention. The metered electrical device charger, comprising: a housing 1000 defined by an outer surface from which a plurality of prongs (three) 1004 are configured to protrude to couple to and receive power from a power source, where the outer surface is defined by at least one stopper 1001 that is configured to hold at least one electrically powered device in position on the housing 1000 while the at least one housing is coupled to the power source; and wherein the housing further comprises at least one payment transaction arrangement 1002. The plurality of prongs three 1004 can be configured to couple to a 220 V or to a 110 V. FIG. 10a has three flat prongs (European electrical plug) 1004a while FIG. 10b shows design for one round prong and two flat prongs (USA electrical plug) 1004b. The payment transaction arrangement 1002 is in-built wireless facility into the housing 1000. The payment transaction arrangement 1002 can accept payment transaction details from the electrically powered devices. The housing 800 has Female socket 1007a with which another adapter/electrical plug can attach. The stopper 1001 in the present embodiment is like a channel or groove type of arrangement; however it can be any different designs which can securely hold the electrically powered device. The stopper 1001 comprises a channel extending into a top of the housing.

In an exemplary embodiment of the present invention, FIG. 11 represents the flow chart of the method of charging an electrically powered device and metering/calculating the electrical power consumption during the charging. In step 1101, at the initiation of the method, the customer walks in to the location or public places. The customer is in need to charge his/her electrically powered device(s). The electrically powered device(s) can be a mobile phone, i-Pad computer device, a music player device, a CD player, a tablet computer, or a laptop computer. The customer opens web-based or mobile-based application on the electrically powered device step 1102. In case the customer does not have web-based or mobile-based application on the electrically powered device then the customer can download from application from the online application store such as Google play store or Apple App store (iOS). At step 1103, the system or application welcomes and prompts the customer to log-in or to register. The customer log-in to the application or the first timer may register to the application step 1104. The customer's identity verified step 1105. At step 1106, the system confirms the identity of the customer. At step 1107, the system tracks the customer's exact location thru GPS location system. Further, the system provides the various option of accessing electricity, such as show cases near-by all the available electrical outlets where the customer can go and plugged in to his/her electrically powered device. At step 1108, the system offers different options of charging, such as whether the customer wants to fully charge his/her device or the customer wants to charge the device for certain period of time. The customer makes selection of the charging option step 1109. At step 1110, further the customer also browses the list of electrically powered devices available on the system and selects the right device which he/she wants to charge. In case the electrically powered device is not listed on the system, then the customer may insert some details about the device, such as type of device, what type of battery require or charging ampere/voltage requirements, etc. The system confirms the selection and provides tentative charges may incur step 1111. At step 1112, the customer finalizes the order. At step 1113, the system provides the payment option to the customer. The payment option can be like online payment by the customer, allowing to swipe the card, deduct the payment from the network service provider (for example, AT&T, Verizon), or to deduct from the customer's account with the electrically powered device manufacturer (for example, Samsung, Apple). The customer makes selection of the payment option step 1114. At step 1115, the system confirms the order. The customer plug-in the electrically powered device to the metered electrical device charger for charging step 1116. At step 1117, the metered electrical device charger completes the charging and sends time-stamp to the cloud server. The application on the cloud server calculates the charging fees step 1118. Further, in case of any interruptions or outages then the system deducts those charging fees accordingly step 1119. The customer finally approves the payment step 1120. At step 1121, the system/application deducts the payment according to the option selected by the customer. The system also provides credit (money) to the location owner from each payment receive from the customer step 1122.

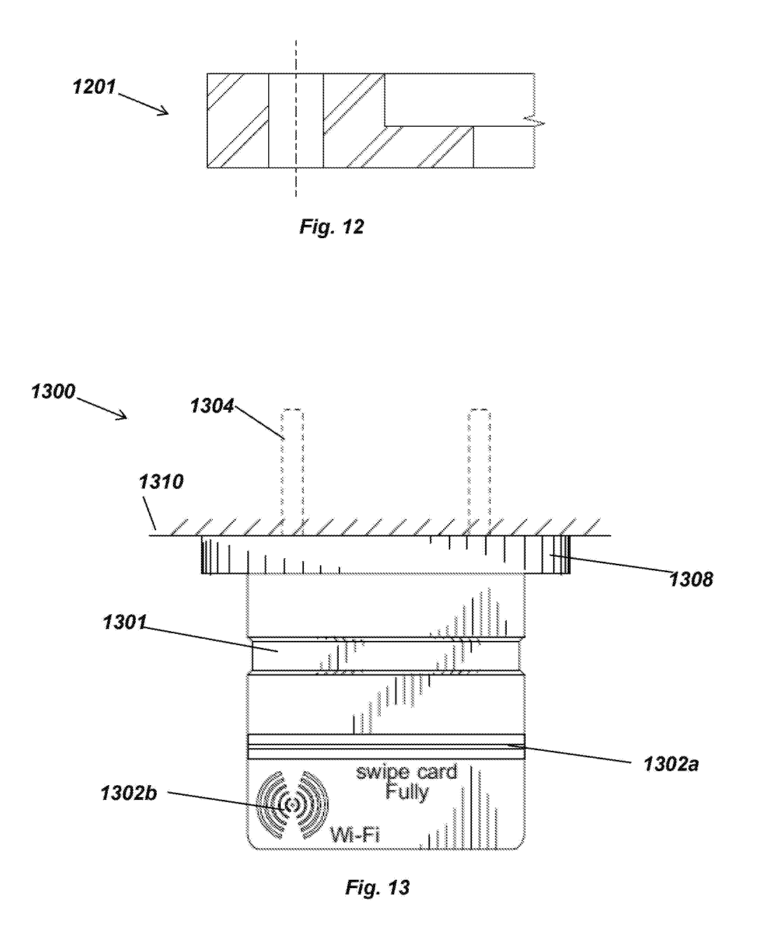

In an exemplary embodiment of the present invention, the metered electrically device charger permanently fixed to the normal electrical outlet to convert it to dedicated electrical outlet. FIGS. 12 to 14 depict the various components of the assembly. FIG. 12 depicts a retaining ring 1201 for dedicated electrical outlet to which a metered electrical device charger is attached. FIG. 13 depicts metered electrical device charger including a stopper, a card swiping slot for the payment transaction, and also in-built wireless facility for the payment transaction. The metered electrical device charger, comprising: a housing 1300 defined by an outer surface from which a plurality of prongs 1304 are configured to protrude to couple to and receive power from a power source, where the outer surface is defined by at least one stopper 1301 that is configured to hold at least one electrically powered device in position on the housing 1300 while the at least one housing is coupled to the power source; and wherein the housing further comprises at least one payment transaction arrangement 1302a and 1302b. The housing further also includes a bracket 908. The plurality of prongs 1304 can be configured to couple to a 220 V or 110 V wall outlet. The payment transaction arrangement 1302a is a card swiping slot on the outer surface of the housing. The payment transaction arrangement 1302b is in-built wireless facility into the housing 1300.

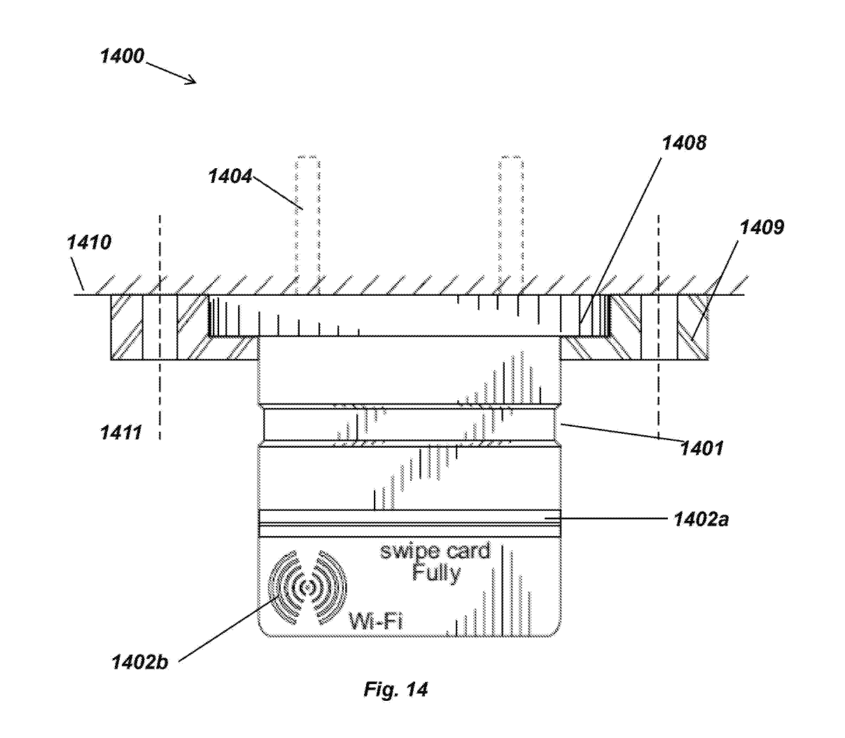

FIG. 14 depicts assembly of metered electrical charger device fixed to the electrical outlet to convert it to dedicated electrical outlet. The metered electrical device charger, comprising: a housing 1400 defined by an outer surface from which a plurality of prongs 1404 are configured to protrude to couple to and receive power from a power source, where the outer surface is defined by at least one stopper 1401 that is configured to hold at least one electrically powered device in position on the housing 1400 while the at least one housing is coupled to the power source; and wherein the housing further comprises at least one payment transaction arrangement 1402a and 1402b. The payment transaction arrangement 1402a is a card swiping slot on the outer surface of the housing. The payment transaction arrangement 1402b is in-built wireless facility into the housing 1400. The plurality of prongs 1404 can be configured to couple to a 220 V or 110 V wall outlet.

The housing further also includes a bracket 1408. Firstly, the metered electrical device charge plugged in to the normal electrical outlet. Then the retaining ring 1409 can be glued to the wall 1410 and further the retaining ring 1409 is also secured to the wall (not shown). The retaining ring 1409 fits over the device (on the bracket 1408 part of the device) and the retaining ring 1409 is epoxied to the wall also butterfly bolts may be inserted into the wall thru the bolt holes 1411 to further secure the device to the dedicated outlet. This assembly converts the normal electrical outlet to the dedicated electrical outlet which can be used 24*7 for the purpose of charging the electrically powered device(s). This assembly also prevents vandalism by securing the metered electrical device charger.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

1. A metered electrical device charger, comprising:
a housing defined by an outer surface from which a plurality of prongs are configured to protrude perpendicularly from to couple to and receive power from an electrical power source comprising a wall outlet, where the outer surface is defined by at least one stopper comprising a channel extending across a top of the housing that is configured to hold at least one electrically powered device in position on top of the housing while the at least one housing is coupled to the power source that is able to recharge the electrically powered device; and
wherein the housing further comprises an in-built wireless facility and at least one payment transaction arrangement comprising a card payment swiping slot that is configured to receive and wirelessly process a credit card, debit card, or smart card;
wherein the payment transaction arrangement is built-into the housing, or is a card swipe reader connected to the housing via an audio jack connector; and
wherein the at least one electrically powered device comprises a smartphone, a mobile phone, an i-Pad computer device, a music player device, a CD player, a tablet computer, or a laptop computer.

2. (canceled)

3. (canceled)

4. The metered electrical device charger of claim 1, wherein the at least one payment arrangement is configured to debit the credit card, debit card, or smart card for usage of the at least one electrically powered device.

5. (canceled)

6. The metered electrical device charger of claim 1, wherein the payment transaction arrangement is a card swipe reader connected to the housing via an audio jack connector.

7. The metered electrical device charger of claim 1, further comprising an electrical cord configured to connect the housing to the at least one electrically powered device.

8. (canceled)

9. The metered electrical device charger of claim 1, wherein along an entire length of the channel, the channel is defined by a cross-sectional shape selected from the group consisting of a right angle, an angle other than a right angle, a curve, and a combination thereof.

10. The metered electrical device charger of claim 1, wherein the plurality of prongs are configured to couple to a 220 V or 110 V wall outlet.

11. The metered electrical device charger of claim 1, wherein the electric power source is selected from the group consisting of: an alternating current (AC) source and a direct current (DC) source.

12. The metered electrical device charger of claim 1, further comprising at least one intelligent chip within the smart card configured to communicate wirelessly with a cloud server.

13. The metered electrical device charger of claim 12, wherein the intelligent chip communicates information comprised of user information, electrical power usage information, location information, or time-stamp information to the cloud server.

14. The metered electrical device charger of claim 13, wherein the location information comprises a location owner name, a location area, or an electrical outlet reference number.

15. The metered electrical device charger of claim 12, wherein the time-stamp information includes a start-up time and a shut off-time that indicates how long the at least one electrically powered device has been electrically connected to the electrical device charger.

16. The metered electrical device charger of claim 1, wherein the at least one electrically powered device comprises a mobile phone, an i-Pad computer device, a music player device, a CD player, a tablet computer, or a laptop computer.

17. The metered electrical device charger of claim 10, further comprising a retaining mechanism by which the electrical device charger is fixedly attached to the wall outlet.

18. The metered electrical device charger of claim 17, wherein the retaining mechanism comprises a retaining ring.

19. The metered electrical device charger of claim 17, wherein the retaining mechanism comprises threads.

20. The metered electrical device charger of claim 1, wherein the electrical device charger is configured to charge the electrically powered device while holding the electrically powered device and to communicate with a cloud server.
